(19) United States
(12) Patent Application Publication
(10) Pub. No.: US 2005/0091220 A1
(43) Pub. Date: Apr. 28, 2005

(54) Method and system for syndicating business information for online search and directories

(76) Inventor: Jason L. Klemow, Gaithersburg, MD (US)

Correspondence Address: DITTHAVONG & CARLSON, P.C., Suite A, 10507 Braddock Road, Fairfax, VA, 22032, US

(21) Appl. No.: 10/975,878

(22) Filed: Oct. 28, 2004

Related U.S. Application Data
(60) Provisional application No. 60/515,087, filed on Oct. 28, 2003.

(51) Int. Cl. G06F 7/00

(52) U.S. Cl. 707/10

(57) ABSTRACT

A multi-tier syndication system is provided to enable each business within a supply chain to publish and consume multiple information feeds on a data network (e.g., the Internet), resulting in a virtual yellow page, which search engine and directories can aggregate in order to easily provide the information to their customers.

### RELATED APPLICATIONS

The present application claims the benefit of U.S. Provisional Patent Application Ser. No. 60/515,087 filed on Oct. 28, 2003 (attorney docket number 01041-1003) entitled “Method and System for Syndicating Business Information for Online Search and Directories,” the contents of which are incorporated by reference.

### FIELD OF THE INVENTION

The present invention relates to syndication and more particularly to online search, business directories, and advertisements.

### BACKGROUND OF THE INVENTION

Traditionally, customers find businesses through directories, such as the printed Yellow Pages. Yellow Pages publishers capture a limited number of businesses within a geographic market and usually update their business information based on the book's printing cycles, usually an annual cycle. Yellow Page publishers, and others, have extended their offerings to the web through Internet Yellow Pages and other online directories.

Online search products, such as, Google™ and Microsoft™ MSN, have provided consumers an alternate method to find local businesses. Unfortunately, the business information found in these online search products are derived from information resellers; many working with the Yellow Page publishers resulting in the same out-of-date, inaccurate information, as well as, under representing the overall number of businesses. Further, while the online search products can provide results based on keywords the business information is categorized by Yellow Page headings and other higher-level categories, limiting the effectiveness of any search result.

Another problem is that many of the listings provided only contain the business's basic information, such as, name, address, and phone number. Key information including listing of product brands and/or services offered is usually not provided. In addition, some of the product and services information offered by the local business are not accessible, owned, or controlled by the individual local businesses, but are owned and controlled by national chains, franchises, manufacturers, distributors, and others. Still another problem is the ability to enable businesses to publish both the required and optional information in a consistent structured format for search engines to aggregate and index into their databases.

Therefore, there is a need for an information service that is easy to use, support multi-tier layers, enables businesses multiple options on where to store the information, and can provide a consistent structure format usable by online search products, online directories, and specialized directories.

### SUMMARY OF THE INVENTION

These and other needs are addressed by the present invention for providing a multi-tier syndication system to enable each business within the supply chain to publish and consume multiple information feeds on the Internet, resulting in a virtual yellow page, which search engine and directories can aggregate in order to easily provide the information to their customers.

According to one aspect of an embodiment of the present invention, a method for supplying business information generated by a plurality of businesses in a multi-tiered relationship is disclosed. The method includes consuming at least one of a first information set syndicated from a first tier business and a second information set syndicated from a second tier business. Additionally, the method includes syndicating a third information set, at a third tier business, by appending value added information to the consumed information set. The third information set includes information for a discovery agent to determine whether the syndicated third information set is to be indexed for an online search or a directory service.

According to another aspect of an embodiment of the present invention, National Chains, National Brands, Manufacturers and other top-level information providers, would publish a feed of their product and service information that local businesses consume, and then syndicate with supplemental information, such as, local address into a virtual yellow page. These virtual yellow pages can be automatically aggregated using Discovery Agents which can crawl, index and store contents into a database according to pre-set preferences. In addition, value added resellers can consume feeds, append, and syndicate themselves into a format which again can be consumed, appended, and further syndicated by local businesses. An example of a Value Added Reseller would be a medical association who organizes and publishes a taxonomy of medical specialties feed that their members can consume and utilize within their own listings.

Another aspect of an embodiment of the present invention, local business will create and syndicate their own virtual yellow pages advertisement, which can be index and combined with other similar businesses to create vertical, horizontal, specialized or self-organizing directories.

Another aspect of an embodiment of the present invention, local business will create and syndicate targeted information for specific discovery agents. Where targeted information may include specialized information, advertisements, promotion, based on agreements between the local business and the discovery agent's owner.

Another aspect of the present invention is the ability to provide feedback to higher tier entities on usage of their syndicated information by lower tier entities.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a system for the multi-tier syndication, discovery, and display of business information according to an embodiment of the present invention;

FIG. 2 is a flow chart illustrating the processing steps performed by the system of FIG. 1 for a Tier 2 Business syndicating Local Business Information based on consuming information syndicated by a Tier 1 Business, such as a, National Chain with Local Options' according to one embodiment of the present invention in accordance with one embodiment of the present invention;

FIG. 3 is a flow chart illustrating the processing steps performed by the system of FIG. 1 for a Local Business syndicating Local Business Information based on consuming information syndicated by two Tier 1 Businesses, such as, a Manufacture and a National Brand according to one embodiment of the present invention;

FIG. 4 is a flow chart illustrating the processing steps performed by the system of FIG. 1 for any Business directly syndicating local business information, such as, a Local Business, a National Chain or Franchise operation, according to one embodiment of the present invention;

FIG. 5 is a flow chart illustrating the processing steps performed by the system of FIG. 1 for any Business syndicating local business and syndicating targeted information for a specific Discovery Agent, such as a paid inclusion advertisement according to one embodiment of the present invention;

FIGS. 6A and 6B are a flow chart illustrating the processing steps performed by the system of FIG. 1 for Consumers locating business information from a web site based on information crawled from a Discovery Agent and included in the possible results of the web site, such as, a Online Search Site or a Directory site according to one embodiment of the present invention;

FIGS. 7A and 7B are a flow chart illustrating the processing steps performed by the system of FIG. 1 for higher tier businesses locating local businesses using their business information by deploying a Feedback Discovery Agent, according to one embodiment of the present invention;

FIG. 8 is a diagram of the Tier 1 Business syndication information using Channel and Item information for syndication according to one embodiment of the present invention;

FIG. 9 is a diagram of the Local Business information using Channel and Item information plus a new “Local Business” namespaces, for syndication according to one embodiment of the present invention;

FIG. 10 is a diagram of the consumer view of a virtual yellow page of a Local Business information as described in FIG. 9 and consuming and re-syndicating, for example, the Zagat's restaurant ratings feed and the Best of Baltimore ratings feed with respect to this business, according to one embodiment of the present invention; and

FIG. 11 is a diagram of a computer system that can be used to implement an embodiment of the present invention.

### DESCRIPTION OF THE PREFERRED EMBODIMENT

A system, method, and software for supporting a multi-tier syndication system are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in diagram form in order to avoid unnecessarily obscuring the present invention.

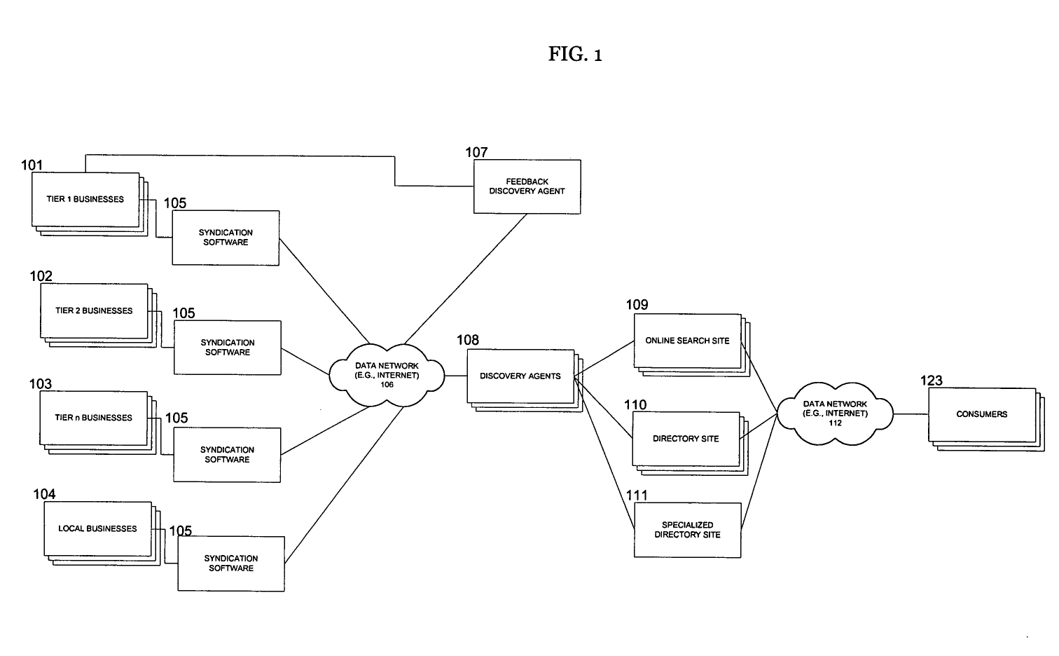

FIG. 1 is a diagram of a system for the multi-tier syndication, discovery, and display of business information according to an embodiment of the present invention. A Business 101 owns and controls information specific to its business, such as, branding, product names and product details. The Business 101 uses syndication software 105 to publishes the information to the world wide web 106 using a Extensible Markup Language (XML) standard so the information is consistent and structured and accessible to other businesses 102, 103, and 104 and by Discovery Agents 107, 108.

According to an embodiment of the present invention, the syndication software 105 leverages an XML-based Web content and metadata syndication format (syndication), which is a data format that allows computers to exchange files containing structured information and is expressed using standard defined XML. One such syndication is Real Simple Syndication (RSS) a lightweight multipurpose extensible metadata description and syndication format. RSS may be further extended with modules using XML and namespaces. A namespace is a prefix applied to Uniform Resource Indicators and XML entities to prevent naming conflicts. RSS is currently used for organizations and individuals to distribute news on the Internet. The same standard or other XML-based Web content and metadata syndication formats can be used by businesses to distribute product, directory and advertisement information. RSS and others have two aspects to syndication: providing a syndication feed for your information and consuming syndicated feeds from other sites. Consumed syndicated feeds can be combined and appended with additional information and then provided as a new syndication feeds. Business may publish syndicated feeds almost anywhere on the World Wide Web including their own web servers, on hosted web sites, or on hosted BLOG (e.g., web log) sites. Hosted BLOG sites are usually provided for free or for a low charge from the providers of BLOG syndication software.

Another example of a syndication format is ATOM, which is an XML-based Web content and metadata syndication format.

RSS and ATOM conforms to the World Wide Web's (W3C's) RDF (Research Development Framework) Specification, which incorporated herein by reference.

Local Businesses 104 may sells goods and provides services where the information with respect to the goods and services is owned and controlled by the other businesses. Local Businesses 104 using syndication software 105 consumes the information syndicated by these other businesses 101, 102, 103, supplements the data with local information, such as, physical location and operating hours and syndicate the new enhanced feed to the world wide web 106 using a XML standard so the information is consistent and structured and accessible by Discovery Agents 107, 108. The Discovery Agent 108 crawls the World Wide Web 106 for the syndicated information and returns the results to Online Search Sites 109 and Directory Sites 110 and Specialized Directories Sites 111 where the information is index and made available over the World Wide Web 112 for Consumers 123 to accesses and view. Feedback Discovery Agents 107 also crawls the World Wide Web 106 for specific syndicated information to understand which Businesses are accessing and syndicating higher tier syndication information. Discovery Agents for Specialized Directory Sites 111, crawl the World Wide Web 106 only for specific Local Business Information. For example, a Health Maintenance Organization or HMO would want to keep the information on its medical professional affiliates up-to-date.

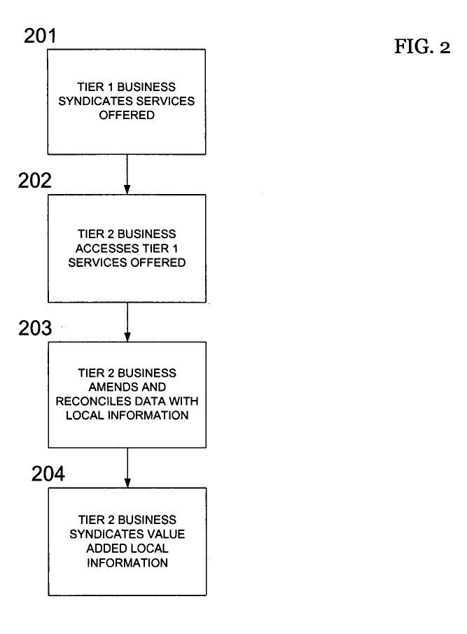

FIG. 2 is a flowchart of a process for syndicating local business information based on higher tier information with local data supplemented in the system of FIG. 1, according to an embodiment of the present invention. The Tier 1 Business syndicates services offerings 201 which the Tier 2 Business 202 consumes and append local information to the data 203 followed by the Tier 2 Business syndicating the final local based information 204.

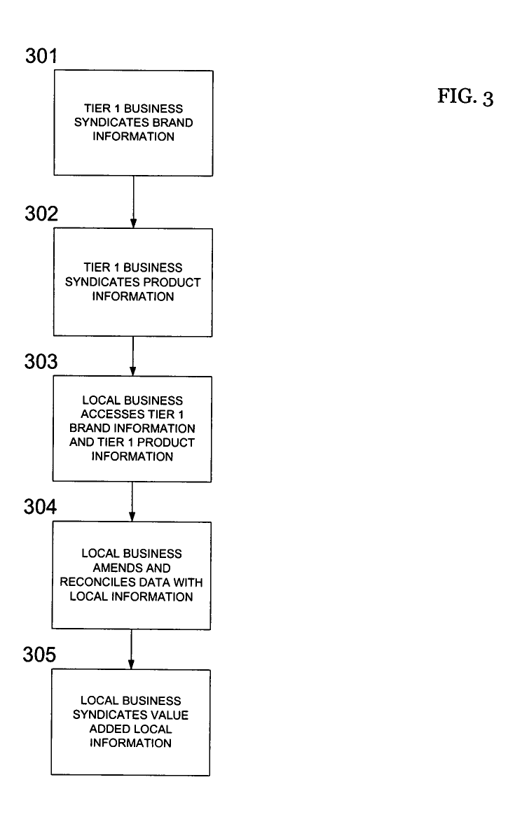

FIG. 3 is a flowchart of a process for syndicating local business information based on two higher tier information sources with local data supplemented in the system of FIG. 1, according to an embodiment of the present invention. The Tier 1 Business syndicates brand information 301 while another Tier 1 Business syndicates product information 302 where the Local Business 303 consumes both feeds and then supplements the data with local information 304 followed by the Local Business syndicating the final local based information feed 305.

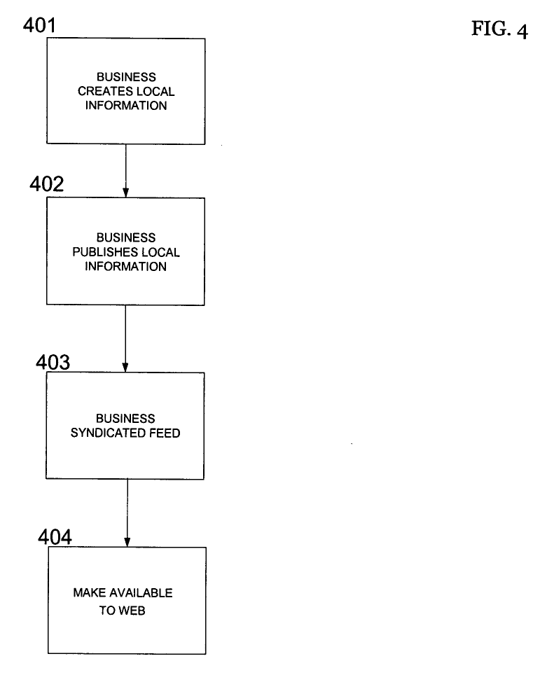

FIG. 4 is a flowchart of a process for a local business syndicating local business information in the system of FIG. 1, according to an embodiment of the present invention. The Local Business creates listing information 401 and publishes the information 402 to create a syndicated feed 403 and made available over the World Wide Web 404.

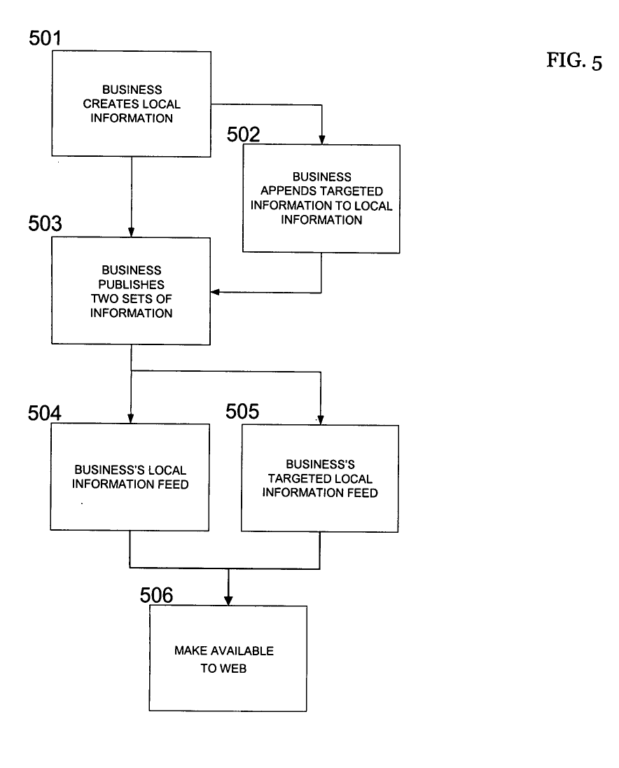

FIG. 5 is a flowchart of a process for a local business syndicating local business information and syndicating targeted local information for a specific Discovery Agent, such as a paid inclusion advertisement in the system of FIG. 1, according to an embodiment of the present invention. The Local Business creates listing information 501, appends the listing information with targeted information 502 and publishes both sets of information 503 to create a non-targeted syndicated feed 504 and a targeted syndicated feed 505, both made available over the World Wide Web 506.

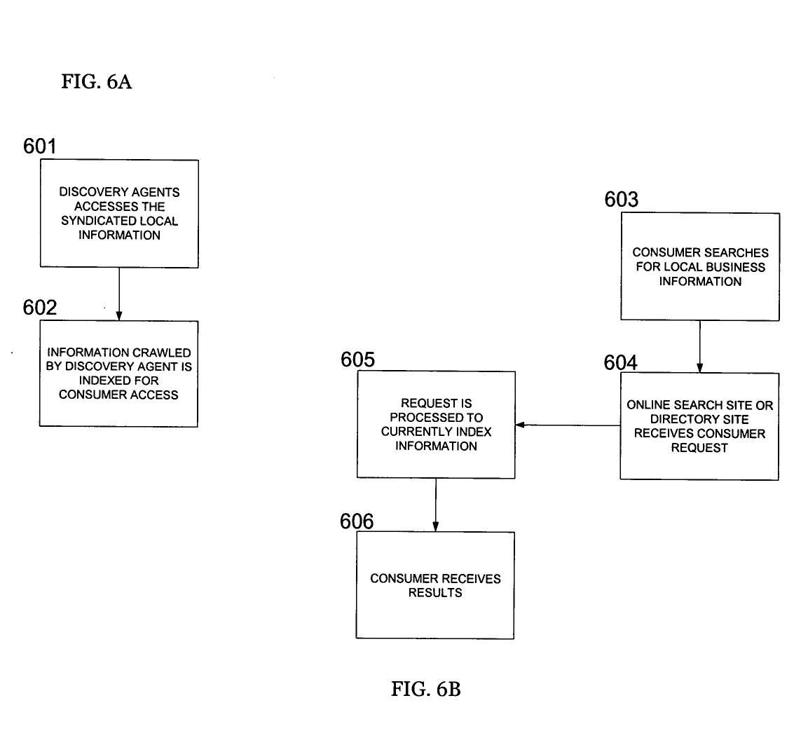

FIGS. 6A and 6B are a flowchart of a process for a Consumers locating business information from a web site based on information crawled from a Discovery Agent and included in the possible results of the web site, such as, an Online Search Site or a Directory site in the system of FIG. 1, according to an embodiment of the present invention. A Discovery Agent 601 crawls the World Wide Web for syndicated business information, when found the information is indexed into the respective Discovery Agent owner's information set 602. When consumers request local business information 603, the request is received by the respective web site 604 and a search of the index information is processed 605, and then the results are provided to the consumer 606.

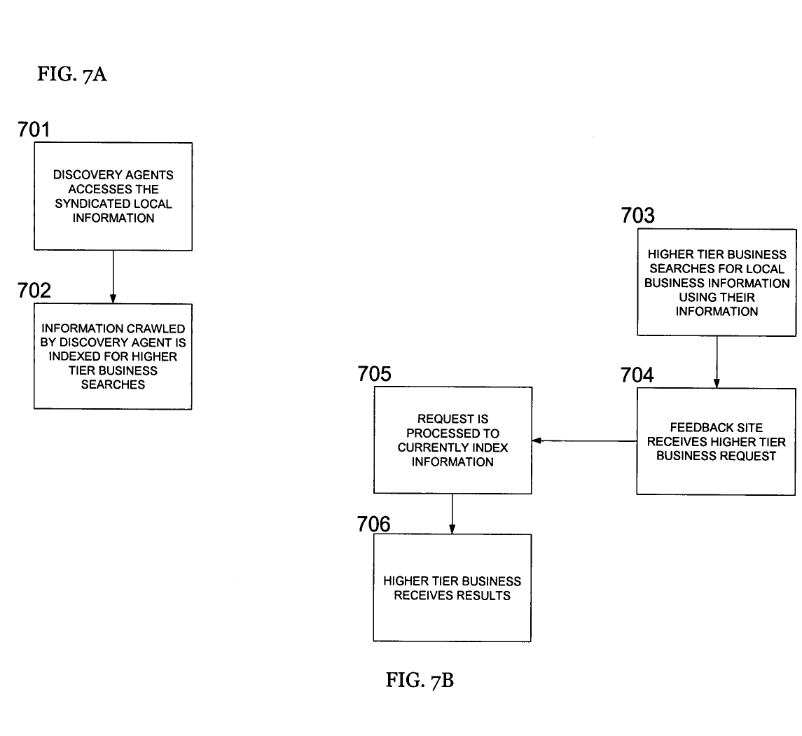

FIGS. 7A and 7B are a flowchart of a process for higher tier businesses locating local businesses using their business information by deploying a Feedback Discovery Agent in the system of FIG. 1, according to an embodiment of the present invention. A Discovery Agent 701 crawls the World Wide Web for syndicated business information with respect to the higher tier business information, when found the information is indexed into the Discovery Agent owner's information set 702. When higher tier business requests local business information using their information 703, the request is received by the respective web site 704 and a search of the index information is processed 705, and then the results are provided to the requesting business 706.

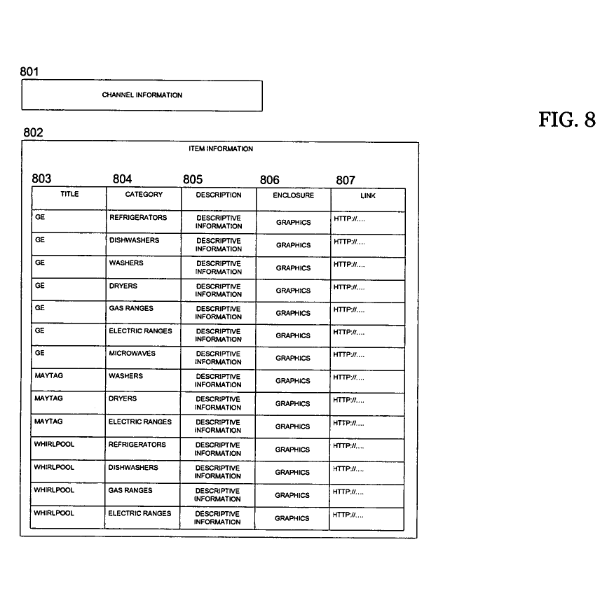

FIG. 8 is a diagram of the Tier 1 Business syndication information using Channel and Item information according to one embodiment of the present invention. The Tier 1 Business formats the header information using the Channel Information 801 which, for example, includes: Title, Link and Description information and may include language, copyright, managing editor, webmaster, published date, last build date, category, generator, docs, cloud, TTL, image, rating, text input, skip hours, and skip days. The Tier 1 Business formats the detail information using the Item Information 802 which includes the following: title, link, description, author, category, comments, enclosure, Globally Unique Identifier (GUID), published date, and source. The example information shown indicates the Tier 1 information providers is providing appliance information, specific to Brand Names, Appliance Categories, plus placeholders for description information, graphics, and a URL for additional product detail.

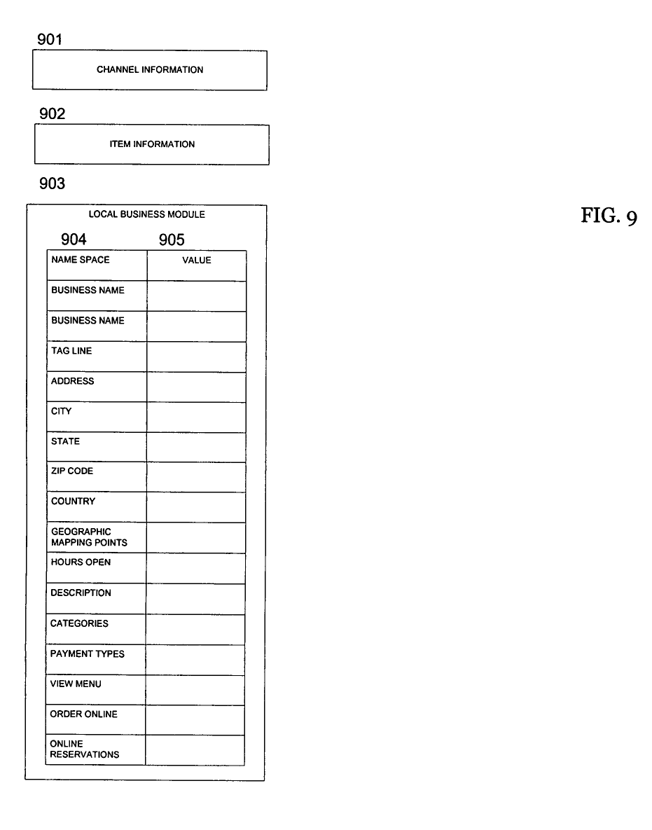

FIG. 9 is a diagram of the Local Business information using Channel and Item information plus a new “Local Business” namespaces, for syndication according to one embodiment of the present invention. The Local Business formats the header information using the Channel Information 901 which includes the following: Title, Link and Description information and may include language, copyright, managing editor, webmaster, published date, last build date, category, generator, docs, cloud, TTL, image, rating, text input, skip hours, and skip days. The Local Business formats the detail information using the Item Information 902 which includes: title, link, description, author, category, comments, enclosure, GUID, published date, and source. The Local Business then formats the Local Business Module 903. Modules may be added to the RSS specification, using namespaces, to form completely new syndication formats. ATOM and other XML-based Web content and metadata syndication format also have capabilities to be expanded similar to RSS Modules. The example shown, which is not inclusive, shows a Business Listing namespace and placeholders for a value for the Business Name, Tag Line, Logo, Address including mapping points, such as longitude and latitude, store hours, business description, categories, payment types accepted, menu information, ordering information, and reservation information. The namespaces values can be linked to other syndication information, such as, the ones found in FIG. 8 or from other resources. An example of the later resource is the ordering information namespace and value. The value may be a link to an electronic commerce site operated by an external third party provider.

Although the above discussions involve a two-tiered model, it is recognized that the approach can be extended to any number of tiers (i.e., n-tiered). For example, a Tier 1 business may syndicate information set A. In addition, another Tier 1 business may syndicate its own information set B. A Tier 2 business then consumes information set A, appending value added information and itself syndicating information set C. Thereafter, a Tier 3 business consumes the information set B and information set C. This Tier 3 business appends additional value added information and syndicates information Set D. Information Set D provides the key structured information that indicates to the discovery agents whether the information should be indexed into their specific online search or directory services. Once indexed, a user searching for a business containing information from set A, B, C and D would find the Tier 3 business.

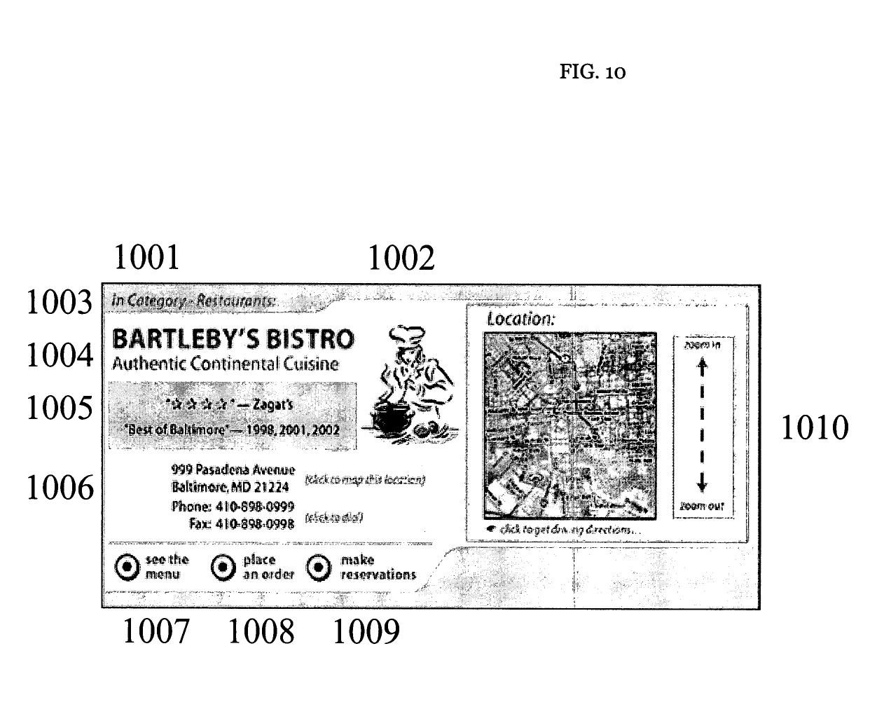

FIG. 10 is a diagram of the consumer view of a virtual yellow page of a Local Business information using syndication as described in FIG. 9 and consuming and re-syndicating, for example, the Zagat's restaurant ratings feed and the Best of Baltimore ratings feed with respect to this business, according to one embodiment of the present invention. The virtual yellow page advertisement 1001 as seen by humans, as opposed to the machine views of FIG. 8 and FIG. 9, shows the published information of Name and Tag Line 1004, Logo 1002, Address 1006, categories 1003, menu information 1007 as a hyperlink, ordering information 1008 as a hyperlink, and reservation information 1009 as a hyperlink, based on the values for within the feeds and a given formatting style. In addition, a Map of the area and business location 1010 is provided based on the mapping points and the re-syndication of other feeds, in this case the Zagat's restaurant ratings feed and the Best of Baltimore ratings feed 105 example. Both Zagat's and Best of Baltimore rating's feed would be considered a higher tier syndication available for use by Local Businesses.

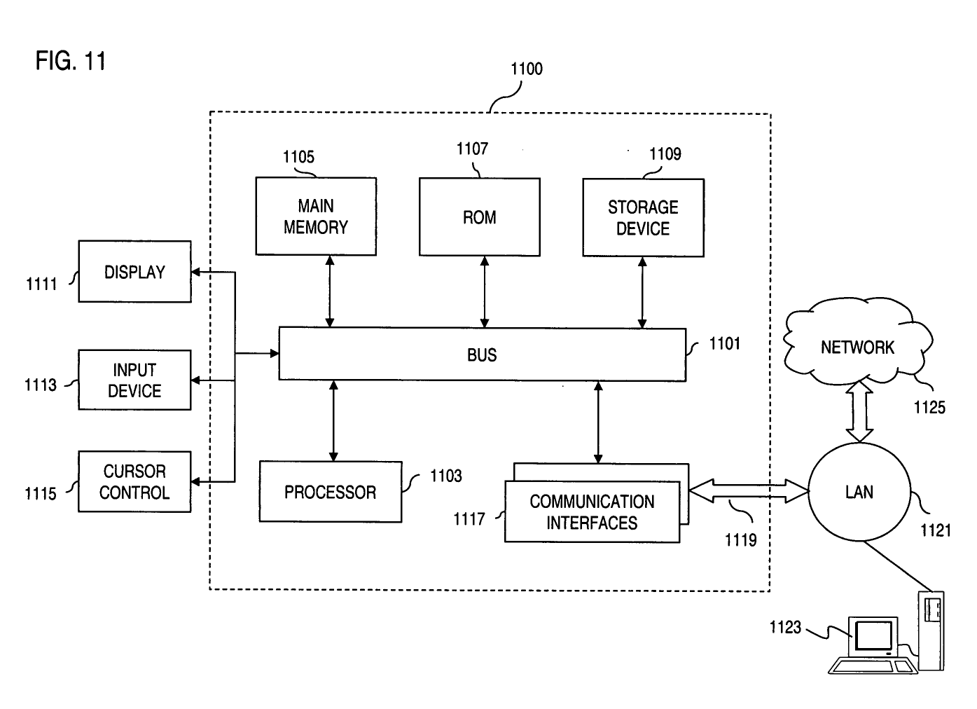

FIG. 11 illustrates a computer system 1100 upon which an embodiment according to the present invention can be implemented. The computer system 1100 includes a bus 1101 or other communication mechanism for communicating information and a processor 1103 coupled to the bus 1101 for processing information. The computer system 1100 also includes main memory 1105, such as a random access memory (RAM) or other dynamic storage device, coupled to the bus 1101 for storing information and instructions to be executed by the processor 1103. Main memory 1105 can also be used for storing temporary variables or other intermediate information during execution of instructions by the processor 1103. The computer system 1100 may further include a read only memory (ROM) 1107 or other static storage device coupled to the bus 1101 for storing static information and instructions for the processor 1103. A storage device 1109, such as a magnetic disk or optical disk, is coupled to the bus 1101 for persistently storing information and instructions.

The computer system 1100 may be coupled via the bus 1101 to a display 1111, such as a cathode ray tube (CRT), liquid crystal display, active matrix display, or plasma display, for displaying information to a computer user. An input device 1113, such as a keyboard including alphanumeric and other keys, is coupled to the bus 1101 for communicating information and command selections to the processor 1103. Another type of user input device is a cursor control 1115, such as a mouse, a trackball, or cursor direction keys, for communicating direction information and command selections to the processor 1103 and for controlling cursor movement on the display 1111.

According to one embodiment of the invention, the process of FIGS. 2-7 are provided by the computer system 1100 in response to the processor 1103 executing an arrangement of instructions contained in main memory 1105. Such instructions can be read into main memory 1105 from another computer-readable medium, such as the storage device 1109. Execution of the arrangement of instructions contained in main memory 1105 causes the processor 1103 to perform the process steps described herein. One or more processors in a multi-processing arrangement may also be employed to execute the instructions contained in main memory 1105. In alternative embodiments, hard-wired circuitry may be used in place of or in combination with software instructions to implement the embodiment of the present invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the present invention are not limited to any specific combination of hardware circuitry and software.

The computer system 1100 also includes a communication interface 1117 coupled to bus 1101. The communication interface 1117 provides a two-way data communication coupling to a network link 1119 connected to a local network 1121. For example, the communication interface 1117 may be a digital subscriber line (DSL) card or modem, an integrated services digital network (ISDN) card, a cable modem, a telephone modem, or any other communication interface to provide a data communication connection to a corresponding type of communication line. As another example, communication interface 1117 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1117 sends and receives electrical, electromagnetic, or optical signals that carry digital data streams representing various types of information. Further, the communication interface 1117 can include peripheral interface devices, such as a Universal Serial Bus (USB) interface, a PCMCIA (Personal Computer Memory Card International Association) interface, etc. Although a single communication interface 1117 is depicted in FIG. 11, multiple communication interfaces can also be employed.

The network link 1119 typically provides data communication through one or more networks to other data devices. For example, the network link 1119 may provide a connection through local network 1121 to a host computer 1123, which has connectivity to a network 1125 (e.g. a wide area network (WAN) or the global packet data communication network now commonly referred to as the “Internet”) or to data equipment operated by a service provider. The local network 1121 and the network 1125 both use electrical, electromagnetic, or optical signals to convey information and instructions. The signals through the various networks and the signals on the network link 1119 and through the communication interface 1117, which communicate digital data with the computer system 1100, are exemplary forms of carrier waves bearing the information and instructions.

The computer system 1100 can send messages and receive data, including program code, through the network(s), the network link 1119, and the communication interface 1117. In the Internet example, a server (not shown) might transmit requested code belonging to an application program for implementing an embodiment of the present invention through the network 1125, the local network 1121 and the communication interface 1117. The processor 1103 may execute the transmitted code while being received and/or store the code in the storage device 1109, or other non-volatile storage for later execution. In this manner, the computer system 1100 may obtain application code in the form of a carrier wave.

The term “computer-readable medium” as used herein refers to any medium that participates in providing instructions to the processor 1105 for execution. Such a medium may take many forms, including but not limited to non-volatile media, volatile media, and transmission media. Non-volatile media include, for example, optical or magnetic disks, such as the storage device 1109. Volatile media include dynamic memory, such as main memory 1105. Transmission media include coaxial cables, copper wire and fiber optics, including the wires that comprise the bus 1101. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims.

1. A method for supplying business information generated by a plurality of businesses in a multi-tiered relationship, the method comprising:
consuming at least one of a first information set syndicated from a first tier business and a second information set syndicated from a second tier business; and
syndicating a third information set, at a third tier business, by appending value added information to the consumed information set, wherein the third information set includes information for a discovery agent to determine whether the syndicated third information set is to be indexed for an online search or a directory service.
